(19) United States
(12) Patent Application Publication
(10) Pub. No.: US 2025/0309659 A1
(43) Pub. Date: Oct. 2, 2025

(54) MULTI-STRING HIGH-VOLTAGE BATTERY PACKS FOR VEHICLES AND METHODS OF CONTROLLING THE SAME

(71) Applicant: Karma Automotive, Inc., Irvine, CA (US)

(72) Inventors: Donya Nojavanzadeh, Irvine, CA (US); Ting Huang, Irvine, CA (US); Andrew Shune, Irvine, CA (US)

(73) Assignee: Karma Automotive, Inc., Irvine, CA (US)

(21) Appl. No.: 19/092,671

(22) Filed: Mar. 27, 2025

Related U.S. Application Data
(60) Provisional application No. 63/571,505, filed on Mar. 29, 2024.

(51) Int. Cl. H02J 7/00; B60L 58/18

(52) U.S. Cl. CPC H02J 7/0013; B60L 58/18; H02J 7/005; H02J 7/00714; H02J 7/007182

(57) ABSTRACT

A vehicle includes an electric motor and a multi-string high-voltage battery pack configured to provide a high output voltage for driving the electric motor. The battery pack includes a positive output terminal, a negative output terminal, a plurality of battery strings, a pre-charge circuit connected to the positive output terminal and to each of the plurality of battery strings, a plurality of positive main contactors, each positive main contactor of the plurality of positive main contactors selectively connecting a corresponding battery string to the positive output terminal, and one or more negative main contactors connecting the plurality of battery strings to the negative output terminal.

### CROSS-REFERENCE TO RELATED APPLICATIONS

This U.S. patent application claims priority under 35 U.S.C. § 119 (e) to U.S. Provisional Application 63/571,505, filed on Mar. 29, 2024. The disclosure of this prior application is considered part of the disclosure of this application and is hereby incorporated by reference in its entirety.

### TECHNICAL FIELD

This disclosure relates to multi-string high-voltage battery packs for vehicles and methods of controlling the same.

### BACKGROUND

A high-voltage battery is a safety-critical component of an electric vehicle. From a functional safety point of view, a serious fault of the high-voltage battery could be a single-point failure of the powertrain, which may lead to a loss of propulsion and/or potentially result in a hazard.

### SUMMARY

One aspect of the disclosure provides a vehicle that includes an electric motor and a multi-string high-voltage battery pack configured to provide a high output voltage for driving the electric motor. The battery back includes a positive output terminal, a negative output terminal, a plurality of battery strings, a pre-charge circuit connected to the positive output terminal and to each of the plurality of battery strings, a plurality of positive main contactors, and one or more negative main contactors connecting the plurality of battery strings to the negative output terminal. Each positive main contactor of the plurality of positive main contactors selectively connects a corresponding battery string to the positive output terminal.

Implementations of the disclosure may include one or more of the following optional features. In some implementations, the pre-charge circuit includes: a pre-charge resistor including first and second terminals, the first terminal of the pre-charge resistor connected to the positive output terminal; a pre-charge contactor including first and second terminals, the first terminal of the pre-charge contactor connected to the second terminal of the pre-charge resistor; and a plurality of diodes. Here, each diode of the plurality of diodes includes: a first terminal connected to a corresponding battery string of the plurality of battery strings; and a second terminal connected to the second terminal of the pre-charge contactor.

In some examples, the vehicle also includes a controller configured to operation operations that includes determining that all of the battery strings are in a normal state; and based on determining that all of the battery strings are in the normal state: closing the one or more negative main contactors; closing a pre-charge contactor of the pre-charge circuit; pre-charging the battery pack without voltage control; closing the plurality of positive main contactors; opening the pre-charge contactor; and starting driving of the vehicle or charging of the battery pack. In these examples, the one or more negative main contractors may include a shared negative main contactor that includes a first terminal connected to each of the battery strings and a second terminal connected to the negative output terminal. The controller may perform additional operations that include: determining that the first battery string of the plurality of battery strings is in a fault-on condition; and based on determining that the first battery string is in the fault-on condition: closing the shared negative main contactor and the pre-charge contactor; determining that a healthy second battery string has a lower output voltage than the first battery string; based on determining that the second battery string has a lower output voltage than the first battery string, pre-charging the battery pack with voltage control; closing the positive main contactors corresponding to healthy battery strings; and opening the pre-charge contactor. On the other hand, the operations performed by the controller may further include: determining that a first battery string of the plurality of battery strings is in a fault-on condition; and based on determining that the first battery string is in the fault-on condition: closing the shared negative main contactor and the pre-charge contactor; determining that a healthy second battery string has a higher output voltage than the first battery string; based on determining that the second battery string has a higher output voltage than the first battery string, pre-charging the battery pack without voltage control; closing the positive main contactors corresponding to healthy battery strings; and opening the pre-charge contactor. Additionally or alternatively, the operations performed by the controller may also include closing the shared negative main contactor and the pre-charge contactor; pre-charging the battery pack; closing the positive main contactors corresponding to healthy battery strings; opening the pre-charge contactor; setting a charging voltage limit to a top-of-charge voltage; charging the battery pack; determining that a charging voltage is constant and a charging current satisfies a threshold; and based on determining that the charging voltage is constant and the charging current satisfies the threshold, discontinuing charging of the battery pack.

In some implementations, the controller performs additional operations that include determining that a first battery string of the plurality of battery strings is in a fault-recovered condition, and based on determining that the first battery string is in the fault-recovered condition: closing the shared negative main contactor and the pre-charge contactor; pre-charging the battery pack with voltage control to the output voltage of a second battery string with the lowest output voltage; closing the positive main contactor corresponding to the second battery string; opening the pre-charge contactor; setting a charging voltage limit to the output voltage of a third battery string having an output voltage greater than the lowest output voltage; charging the battery pack; determining that a first charging voltage is constant and the charging current satisfies a first threshold; and based on determining that the first charging voltage is constant and the charging current satisfies the first threshold: discontinuing charging of the battery pack; closing the positive main contactor corresponding to the third battery string; setting a charging voltage limit to a top-of-charge voltage; charging the battery pack; determining that a second charging voltage is constant and the charging current satisfies a second threshold; and based on determining that the second charging voltage is constant and the charging current satisfies the second threshold, discontinuing charging of the battery pack.

In some examples, the controller performs additional operations that include determining that a first battery string of the plurality of battery strings is in a fault-recovered condition, and based on determining that the first battery string is in the fault condition: closing the shared negative main contactor and the pre-charge contactor; pre-charging the battery pack without voltage control; closing the positive main contactor corresponding to a second battery string having the highest output voltage; opening the pre-charge contactor; determining that an output voltage of the second battery string satisfies a threshold; and based on determining that the output voltage of the second battery string satisfies the threshold, closing the positive main contactor corresponding to a third battery string having a lower output voltage than the output voltage of the second battery string.

In some implementations, the one or more negative main contactors include a negative main contractor corresponding to each battery string and each negative main contractor of the one or more negative main contactors includes: a first terminal connected to a corresponding battery string of the plurality of battery strings; and a second terminal connected to the negative output terminal. In these implementations, the operations performed by the controller may also include determining that a first battery string of the plurality of battery strings is in a fault-on condition, and based on determining that the first battery string is in the fault-on condition: closing the negative main contactors corresponding to healthy battery strings; closing the pre-charge contactor; pre-charging the battery pack without voltage control; closing the positive main contactors corresponding to the healthy battery strings; and opening the pre-charge contactor. Additionally, the controller may perform additional operations that include setting a charge voltage limit to a top-of-charge voltage, charging battery pack, determining that a charging voltage is constant and the charging current satisfies a threshold, and based on determining that the charging voltage is constant and the charging current satisfies the threshold, discontinuing charging of the battery pack. Additionally or alternatively, the controller may perform additional operations that include determining that a first battery string of the plurality of battery strings is in a fault-recovered condition, and based on determining that the first battery string is in the fault-recovered condition: closing the negative main contactor corresponding to a second battery string having the lowest output voltage; closing the pre-charge contactor; pre-charging the battery pack without voltage control; closing the positive main contactor corresponding to the second battery string; opening the pre-charge contactor; setting a charge voltage limit to voltage of a third battery string having an output voltage greater than the lowest output voltage; charging the battery pack; determining that a first charging voltage is constant and the charging current satisfies a first threshold; and based on determining that the first charging voltage is constant and the charging current satisfies the first threshold: discontinuing charging of the battery pack; closing the positive main contactor corresponding to the third battery string; setting a charge voltage limit to a top-of-charge voltage; charging the battery pack; determining that a second charging current is constant satisfies a second threshold; and based on determining that the second charging voltage is constant and the charging current satisfies the second threshold, discontinuing charging of the battery pack.

Another aspect of the disclosure provides a computer-implemented method executing on data processing hardware that causes the data processing hardware to perform operations for controlling a multi-string high-voltage battery pack of a vehicle to provide a high output voltage for driving an electric motor of the vehicle. The operations include closing one or more negative main contactors of the battery pack and closing a pre-charge contactor of a pre-charge circuit of the battery pack. The one or more negative main contactors connect a plurality of battery strings of the battery pack to a negative output terminal of the battery pack. The pre-charge circuit is connected to a positive output terminal of the battery pack and each of the plurality of battery strings. The operations also include pre-charging the battery pack, closing a plurality of positive main contactors of the battery pack, and opening the pre-charge contactor. Each positive main contactor of the plurality of positive main contactors selectively connects a corresponding battery string to the positive output terminal.

This aspect may include one or more of the following optional features. In some implementations, the one or more negative main contactors include a shared negative main contactor that includes a first terminal connected to each of the battery strings and a second terminal connected to the negative output terminal. In these implementations, the operations may also include determining that a first battery string of the plurality of battery strings is in a fault-on condition, and based on determining that the first battery string is in the fault-on condition: closing the shared negative main contactor and the pre-charge contactor; determining that a healthy second battery string has a lower output voltage than the first battery string; based on determining that the second battery string has a lower output voltage than the first battery string, pre-charging the battery pack with voltage control; closing the positive main contactors corresponding to healthy battery strings; and opening the pre-charge contactor. On the other hand, the operations may also include determining that a first battery string of the plurality of battery strings is in a fault-on condition; and based on determining that the first battery string is in the fault-on condition: closing the shared negative main contactor and the pre-charge contactor; determining that a healthy second battery string has a higher output voltage than the first battery string; based on determining that the second battery string has a higher output voltage than the first battery string, pre-charging the battery pack without voltage control; closing the positive main contactors corresponding to healthy battery strings; and opening the pre-charge contactor. Additionally or alternatively, the operations may also include closing the shared negative main contactor and the pre-charge contactor; pre-charging the battery pack; closing the positive main contactors corresponding to healthy battery strings; opening the pre-charge contactor; setting a charging voltage limit to a top-of-charge voltage; charging the battery pack; determining that a charging voltage is constant and a charging current satisfies a threshold; and based on determining that the charging voltage is constant and the charging current satisfies the threshold, discontinuing charging of the battery pack.

In some implementations, the operations include determining that a first battery string of the plurality of battery strings is in a fault-recovered condition, and based on determining that the first battery string is in the fault-recovered condition: closing the shared negative main contactor and the pre-charge contactor; pre-charging the battery pack with voltage control to the output voltage of a second battery string with the lowest output voltage; closing the positive main contactor corresponding to the second battery string; opening the pre-charge contactor; setting a charging voltage limit to the output voltage of a third battery string having an output voltage greater than the lowest output voltage; charging the battery pack; determining that a first charging voltage is constant and the charging current satisfies a first threshold; and based on determining that the first charging voltage is constant and the charging current satisfies the first threshold: discontinuing charging of the battery pack; closing the positive main contactor corresponding to the third battery string; setting a charging voltage limit to a top-of-charge voltage; charging the battery pack; determining that a second charging voltage is constant and the charging current satisfies a second threshold; and based on determining that the second charging voltage is constant and the charging current satisfies the second threshold, discontinuing charging of the battery pack.

In some examples, the operations also include determining that a first battery string of the plurality of battery strings is in a fault-recovered condition, and based on determining that the first battery string is in the fault condition: closing the shared negative main contactor and the pre-charge contactor; pre-charging the battery pack without voltage control; closing the positive main contactor corresponding to a second battery string having the highest output voltage; opening the pre-charge contactor; determining that an output voltage of the second battery string satisfies a threshold; and based on determining that the output voltage of the second battery string satisfies the threshold, closing the positive main contactor corresponding to a third battery string having a lower output voltage than the output voltage of the second battery string.

In some implementations, the one or more negative main contactors include a negative main contractor corresponding to each battery string and each negative main contractor of the one or more negative main contactors includes: a first terminal connected to a corresponding battery string of the plurality of battery strings; and a second terminal connected to the negative output terminal. In these implementations, the operations may also include determining that a first battery string of the plurality of battery strings is in a fault-on condition, and based on determining that the first battery string is in the fault-on condition: closing the negative main contactors corresponding to healthy battery strings; closing the pre-charge contactor; pre-charging the battery pack without voltage control; closing the positive main contactors corresponding to the healthy battery strings; and opening the pre-charge contactor. Additionally, the operations may also include setting a charge voltage limit to a top-of-charge voltage, charging battery pack, determining that a charging voltage is constant and the charging current satisfies a threshold, and based on determining that the charging voltage is constant and the charging current satisfies the threshold, discontinuing charging of the battery pack. Additionally or alternatively, the operations may also include include determining that a first battery string of the plurality of battery strings is in a fault-recovered condition, and based on determining that the first battery string is in the fault-recovered condition: closing the negative main contactor corresponding to a second battery string having the lowest output voltage; closing the pre-charge contactor; pre-charging the battery pack without voltage control; closing the positive main contactor corresponding to the second battery string; opening the pre-charge contactor; setting a charge voltage limit to voltage of a third battery string having an output voltage greater than the lowest output voltage; charging the battery pack; determining that a first charging voltage is constant and the charging current satisfies a first threshold; and based on determining that the first charging voltage is constant and the charging current satisfies the first threshold: discontinuing charging of the battery pack; closing the positive main contactor corresponding to the third battery string; setting a charge voltage limit to a top-of-charge voltage; charging the battery pack; determining that a second charging current is constant satisfies a second threshold; and based on determining that the second charging voltage is constant and the charging current satisfies the second threshold, discontinuing charging of the battery pack.

In some examples, the operations also include determining that a first battery string of the plurality of battery strings is in a fault-recovered condition, and based on determining that the first battery string is in the fault-recovered condition: closing the negative main contactor corresponding to a second battery string having the highest output voltage; closing the pre-charge contactor; pre-charging the battery pack without voltage control; closing the positive main contactor corresponding to the second battery string; opening the pre-charge contactor; determining that an output voltage of the second battery string satisfies a threshold; and based on determining that the output voltage of the second battery string satisfies the threshold, closing the positive main contactor corresponding to a third battery string.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example vehicle including a multi-string high-voltage battery pack.

FIG. 2A is a schematic view of an example multi-string high-voltage battery pack.

FIG. 2B is a schematic view of another example multi-string high-voltage battery pack.

FIG. 3 is a flowchart of an example arrangement of operations for a method of controlling a multi-string high-voltage battery pack in a normal condition.

FIG. 4 is a flowchart of an example arrangement of operations for a method of controlling a multi-string high-voltage battery pack in a fault-on condition for a driving mode.

FIG. 5 is a flowchart of an example arrangement of operations for a method of controlling a multi-string high-voltage battery pack in a fault-on condition for a charging mode.

FIGS. 6A and 6B are flowcharts of an example arrangement of operations for a method of controlling a multi-string high-voltage battery pack in a fault-recovered condition for a charging mode.

FIGS. 7A and 7B are flowcharts of an example arrangement of operations for a method of controlling a multi-string high-voltage battery pack in a fault-recovered condition for a driving mode.

FIG. 8 is a schematic view of an example proportional-integral (PI) controller.

FIG. 9 is a schematic view of an example computing device that may be used to implement the systems and methods described herein.

Like reference symbols in the various drawings indicate like elements.

### DETAILED DESCRIPTION

A high-voltage battery is a safety-critical component of an electric vehicle. From a functional safety point of view, a serious fault of the high-voltage battery could be a single-point failure of the powertrain, which may lead to a loss of propulsion and potentially result in a hazard. Accordingly, there is a need for improved high-voltage batteries that are reliable in fault conditions.

Disclosed implementations include a vehicle having a multi-string high-voltage battery pack that includes two or more parallel high-voltage battery strings, a pre-charge circuit shared by the battery strings, and a corresponding positive main contractor for each battery string. Disclosed battery packs may be controlled to provide redundancy in fault conditions and/or unbalanced conditions and, thus, to increase the reliability of the battery packs. Notably, disclosed multi-string high-voltage battery packs may be controlled to pre-charge a load using a single common pre-charge contactor for all the battery strings, which is beneficial from a cost and footprint standpoint. The multi-string high-voltage battery pack may be controlled for driving and charging during normal, fault-on, and fault-recovered conditions.

As used herein, a normal condition may refer to a condition in which all of the battery strings may be simultaneously charged and discharged. In normal conditions, it is safe to connect all of the battery strings together because there has not been a recent fault, and the battery strings are almost substantially balanced (e.g., have states of charge (SOCs) and/or states of power (SOPs) that are all within a threshold of each other).

As used herein, a fault-on condition may refer to a condition in which at least one battery string is faulty such that it cannot or should not be used operationally. In the fault-on condition, a faulty battery string may be at least temporarily isolated from other battery strings to protect the hardware or to support the drivability of the vehicle. During a fault-on condition, driving/charging may continue if at least one string is still operational. Vehicle operation (driving/charging) during fault-on mode may result in an unbalanced condition in which the SOCs of the faulty battery strings may be different from those of healthy strings. Here, the SOC imbalance may be subsequently corrected by performing an SOC balancing method once the fault is recovered. A healthy string may refer to any battery string that is operating without any fault condition. For example, a healthy battery string may be a battery string with an SOC, an SOP, an output voltage, etc. that is substantially nominal.

As used herein, a fault-recovered condition may refer to a condition in which all strings are operating normally and can again all be charged and discharged. However, due to a recent history of driving/charging in a fault-on condition, the SOCs or SOPs of the battery strings may be unbalanced. For example, they may have different output voltages. Therefore, in some implementations, operations are performed in the fault-recovered condition to selectively open/close contactors in driving/charging conditions in a safe way that enables the re-balancing of battery strings.

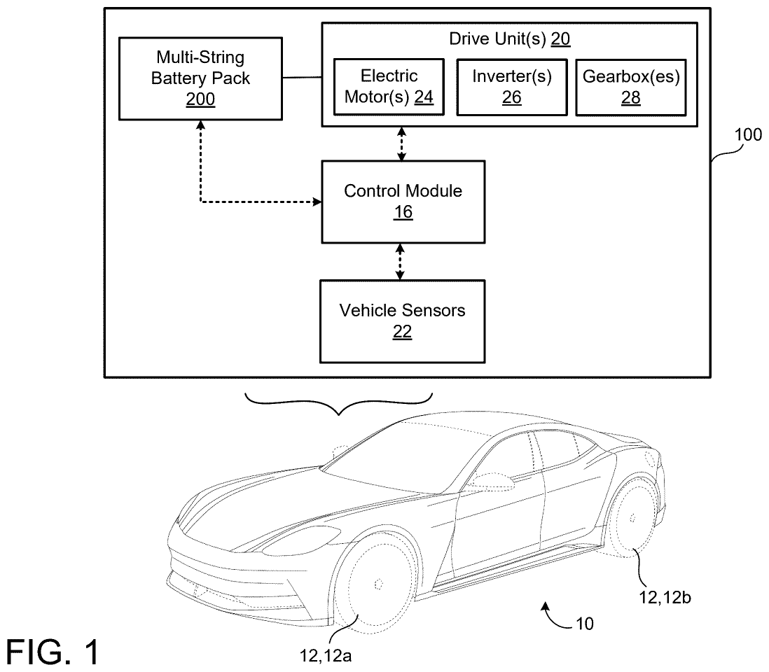

Referring to FIG. 1, a vehicle 10, such as a battery-powered electric vehicle, a hybrid vehicle, a plug-in hybrid electric vehicle includes a vehicle controller 100. In some implementations, the vehicle controller 100 includes a vehicle control module 16 (also referred to herein as control module 16), one or more drive units 20, and one or more vehicle sensors 22 implemented on the vehicle 10. In some configurations, the vehicle 10 is a battery-powered electric vehicle, a hybrid electric vehicle, or a plug-in hybrid electric vehicle such that each drive unit 20 includes one or more electric motors 24, one or more inverters 26, and one or more gearboxes 28. The vehicle 10 may also include one or more wheels 12, 12a-n implemented on the vehicle 10. The vehicle 10 may be any type of vehicle, such as a sedan, a truck, a boat, or a motorcycle.

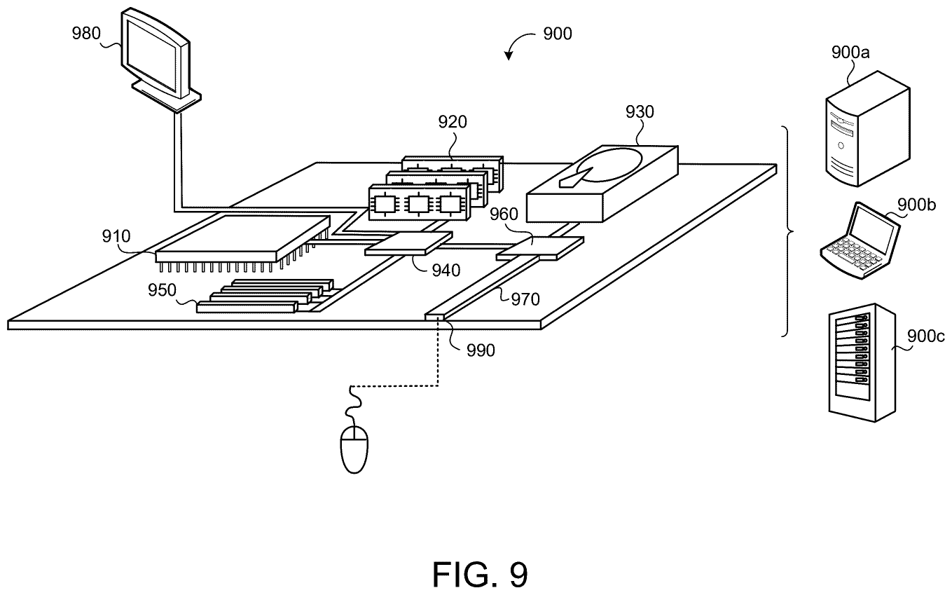

The control module 16 is configured to control operation of the vehicle 10 and may include data processing hardware 910 (FIG. 9) and memory hardware 920 (FIG. 9) in communication with the data processing hardware 910 and storing instructions that, when executed on the data processing hardware 910, cause the data processing hardware 910 to perform operations. In particular, the control module 16 may send control signals to the inverter(s) 26 to control the operation of one or more electric motors 24 implemented on the vehicle 10 based on sensor data received from the one or more vehicle sensors 22.

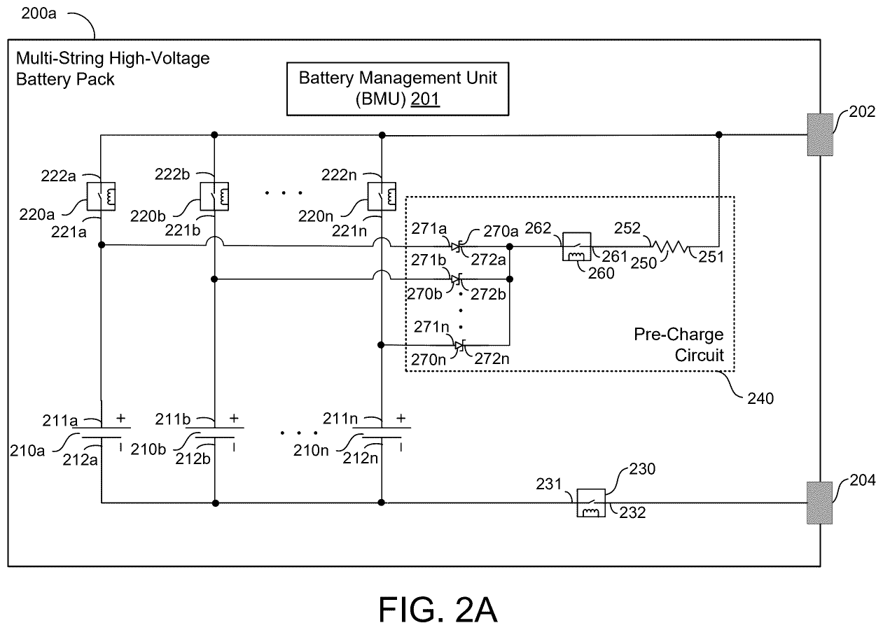

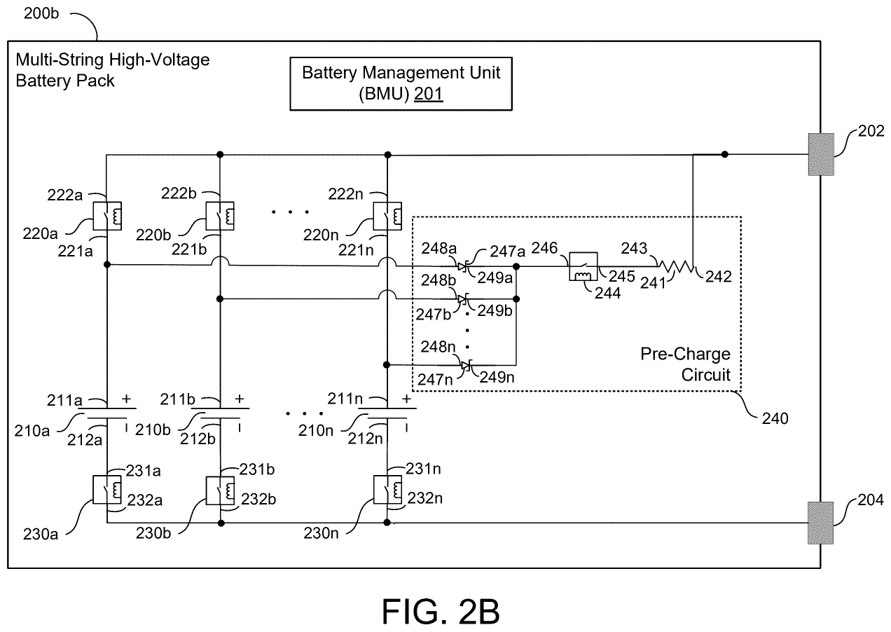

A multi-string high-voltage battery pack 200 (also referred to herein as battery pack 200) of the vehicle 10 supplies the electric power for operating the inverter(s) 26, which is electrically coupled between the battery pack 200 and the electric motor(s) 24. The battery pack 200 includes a plurality of parallel battery strings 210 (see FIGS. 2A and 2B). In some implementations, a battery management unit (BMU) 201 (see FIGS. 2A and 2B) of the battery pack 200 controls contactors 230, 240, 260 of the battery pack 200 to provide redundancy in fault-on conditions and/or fault-recovery conditions to increase the reliability of the battery pack 200. Notably, the battery pack 200 may be controlled to pre-charge a load using a single common pre-charge contactor 224 for all the battery strings 210, which is beneficial from a cost and footprint standpoint. The BMU 201 (also referred to herein as BMU 201), controls the battery pack 200 for driving and charging during normal, fault-on, and fault-recovered conditions. For clarity of explanation, the following disclosure refers to the BMU 201 for performing operations for controlling the battery pack 200. However, one or more of the operations for controlling the battery pack 200 may be performed by other controllers or ECUs of the vehicle 10, such as the control module 16, a powertrain control unit (PCU) ECU, and/or an ECU responsible for the active discharge of a high-voltage bus by, for example, the inverter(s) 26 powering an electric motor(s) 24.

FIG. 2A is a schematic view of an example multi-string high-voltage battery pack 200a (also referred to herein as battery pack 200a) configured to provide a high output voltage for driving, for example, the inverter 26, which powers the electric motor(s) 24. The battery pack 200a forms the high output voltage across a positive output terminal 202 and a negative output terminal 204 of the battery pack 200a.

The battery pack 200a includes a plurality of high-voltage battery strings 210, 210a-n (also referred to herein as battery strings 210), and a plurality of positive main contactors 220, 220a-n. Each positive main contactor 220 of the plurality of positive main contactors 220 selectively connects (e.g., under control of the BMU 201 via control inputs that are not shown for clarity of illustration) a corresponding battery string 210 to the positive output terminal 202. In particular, a first terminal 221, 221a-n of each positive main contactor 220 is connected to the first terminal 211, 211a-n of a corresponding battery string 210, and a second terminal 222, 222a-n of each positive main contactor 220 is connected to the positive output terminal 202.

In the example shown, the battery pack 200a also includes a shared negative main contactor 230. The negative main contactor 230 selectively connects (e.g., under the control of the BMU 201 via control inputs that are not shown for clarity of illustration) each battery string 210 to the negative output terminal 204. In particular, a first terminal 231 of the negative main contactor 230 is connected to the second terminal 212 of each of the battery strings 210, and a second terminal 232 of the negative main contactor 230 is connected to the negative output terminal 204.

The battery pack 200a also includes a pre-charge circuit 240 for selectively pre-charging (e.g., under control of the BMU 201 via control inputs that are not shown for clarity of illustration) a load of the battery pack 200 using any combination of the battery strings 210. The pre-charge circuit 240 includes a pre-charge resistor 250 including a first terminal 251 and a second terminal 252. The first terminal 251 of the pre-charge resistor 250 is connected to the positive output terminal 202. The pre-charge circuit 240 also includes a pre-charge contactor 260 including a first terminal 261 and a second terminal 262. The first terminal 261 of the pre-charge contactor 260 is connected to the second terminal 252 of the pre-charge resistor 250. The pre-charge circuit 240 also includes a plurality of diodes 270, 270a-n. Each diode 270 of the plurality of diodes 270 includes a corresponding first terminal 271, 271a-n connected to the first terminal 211 of a corresponding battery string 210 of the plurality of battery strings 210, and a corresponding second terminal 272 connected to the second terminal 262 of the pre-charge contactor 260.

FIG. 2B is a schematic view of an example multi-string high-voltage battery pack 200b (also referred to herein as battery pack 200b) configured to provide a high output voltage for driving, for example, the inverter 26, which powers the electric motor(s) 24. The battery pack 200b is similar to the battery pack 200a, except that instead of a shared negative main contactor 230, the battery pack 200b includes a plurality of negative main contactors 230, 230a-n for selectively connecting (e.g., under control of the BMU 201 via control inputs that are not shown for clarity of illustration) corresponding ones of the battery strings 210 to the negative output terminal 204. In particular, each negative main contactor 230 includes a corresponding first terminal 231, 231a-n connected to the second terminal 212a of a corresponding battery string 210, and a corresponding second terminal 232, 232a-n connected to the negative terminal 204.

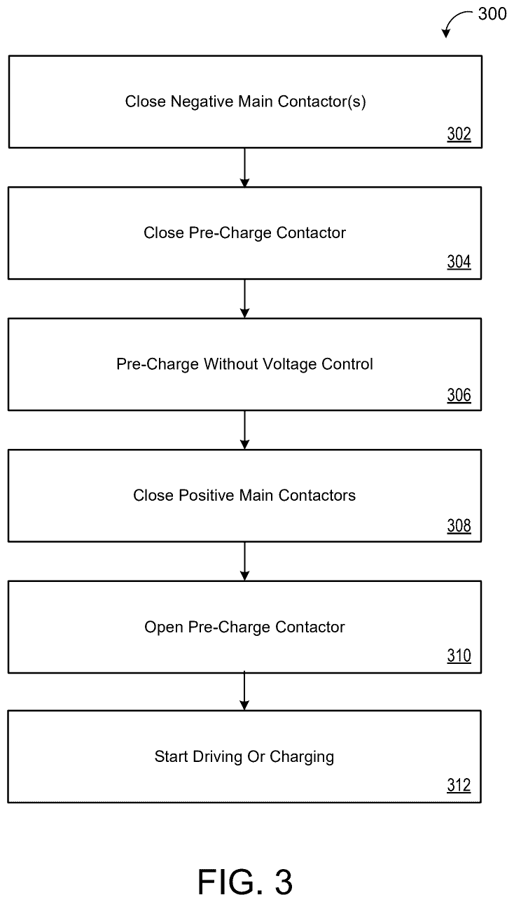

FIG. 3 is a flowchart of an example arrangement of operations for a method 300 of controlling a multi-string high-voltage battery pack 200 in a normal condition. Data processing hardware 910 (FIG. 9) may execute instructions stored on memory hardware 920 (FIG. 9) that cause the data processing hardware 910 to perform operations of the method 300. The data processing hardware 910 and the memory hardware 920 may reside on the BMU 201, the control module 16, a PCU ECU, an ECU responsible for the active discharge of a high-voltage bus, or any other ECU or control module of a vehicle 10.

At operation 302, the method 300 includes closing the negative main contactor(s) 230. At operation 304, the method 300 includes closing the pre-charge contactor 260. The method includes, at operation 306, pre-charging a load without voltage control. By, for example, waiting a pre-determined period of time. At operation 308, the method 300 includes closing the positive main contactors 220. At operation 310, the method 300 includes opening the pre-charge contactor 260. At operation 310, the method 300 includes starting driving of the vehicle 10 or charging of the battery pack 200.

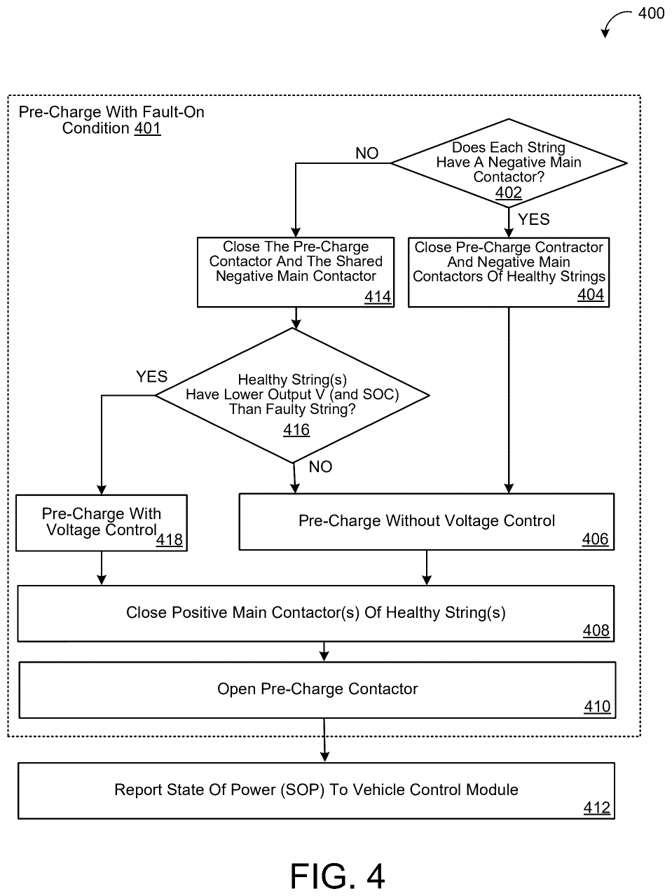

FIG. 4 is a flowchart of an example arrangement of operations for a method 400 of controlling a multi-string high-voltage battery pack 200 in a fault-on condition for a driving mode. Here, it is assumed that only a single battery string 210 is faulty and the other battery strings 210 are healthy (e.g., without a fault or operating nominally). However, the operations performed by the method 400 can be readily extended to cover a fault in more than one battery string 210. The method 400 may be performed based on determining that a particular battery string of the plurality of battery strings is in a fault-on condition. In some examples, the fault is due to the triggering of an emergency power off of the battery string, a battery cell failure (e.g., a voltage across a battery cell exceeding a threshold), or an SOP that is too low to be operating safely. Data processing hardware 910 (FIG. 9) may execute instructions stored on memory hardware 920 (FIG. 9) that cause the data processing hardware 910 to perform operations of the method 400. The data processing hardware 910 and the memory hardware 920 may reside on the BMU 201, the control module 16, a PCU ECU, an ECU responsible for the active discharge of a high-voltage bus, or any other ECU or control module of a vehicle 10.

The method 400 includes a pre-charge with fault-on condition process at operation 401. At operation 402, the method 400 determines whether each battery string 210 has its own negative main contactor 230. At operation 404, the method 400 includes, based on determining that each battery string 210 has its own negative contactor 230 (i.e., operation 402 is “YES”), closing the negative main contactors 230 corresponding to the healthy battery strings 210 and the pre-charge contactor 260. At operation 406, the method 400 includes pre-charging a load without voltage control. By, for example, waiting a pre-determined period of time. At operation 408, the method 400 includes closing the positive main contactors 220 corresponding to the healthy battery strings 210. At operation 408, the method 400 includes opening the pre-charge contactor 260. At operation 412, the method 400 includes reporting the SOP of the battery pack 200 to the control module 16, such that the control module 16 may control a start of driving.

At operation 414, the method 400 includes, based on determining that each battery string 210 does not have its own negative contactor 230 (i.e., operation 402 is “NO”), closing the shared negative main contactor 230 and the pre-charge contactor 260. At operation 416, the method 400 includes determining whether the healthy battery strings 210 have lower output voltages and/or SOCs than the faulty battery string 210. At operation 416, the method 400 includes, determining whether the healthy battery strings 210 have lower output voltages and/or SOCs than the faulty battery string 210. At operation 406, the method 400 includes, based on determining that the healthy battery strings 210 do not have lower output voltages and/or SOCs than the faulty battery string 210 (i.e., operation 416 is “NO”), pre-charging a load without voltage control. By, for example, waiting a pre-determined period of time.

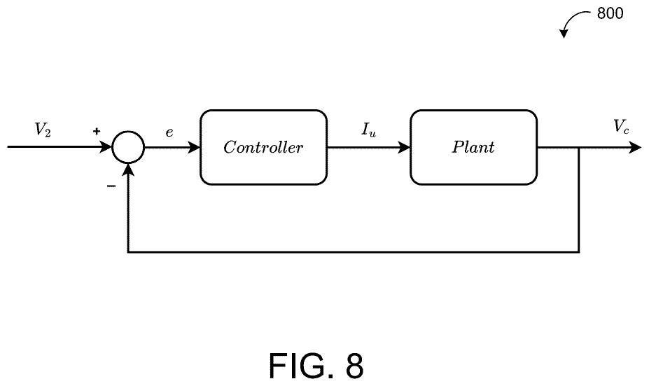

At operation 418, the method 400 includes, based on determining that the healthy battery strings 210 have lower output voltages and/or SOCs than the faulty battery string 210 (i.e., operation 416 is “YES”), pre-charging a load with voltage control. When a battery string 210 is faulty its output voltage will be V₁, while the output voltages of the healthy battery strings 210 will be V₂. If the vehicle 10 has been operated after the faulty battery string 210 has been isolated (i.e., after its corresponding positive main contactor 220 opened), then V₁>V₂. Thus, at a subsequent start of charging or driving, the voltage of the load needs to be pre-charged or increased from its current voltage Ve to the output voltage V₂ of the healthy battery strings 210, which can be controlled using a proportional-integral (PI) controller 800 (see FIG. 8) to correct for the difference between V_{c} and V₂. Here, the PI controller 800 may control the load voltage Ve based on the following expression:

$${I}_{u} ( t ) = - ( {K}_{P} e ( t ) + {K}_{I} \int e ( t ) dt ) , \qquad Equation ( 1 )$$

where e(t)=V₂(t)−V_{c}(t), and K_{P} and K_{I} are coefficients that adjust the relative contributions from the proportional (P) and integrative (I) aspects of the PI controller 800. FIG. 8 is a schematic view of an example PI controller 800.

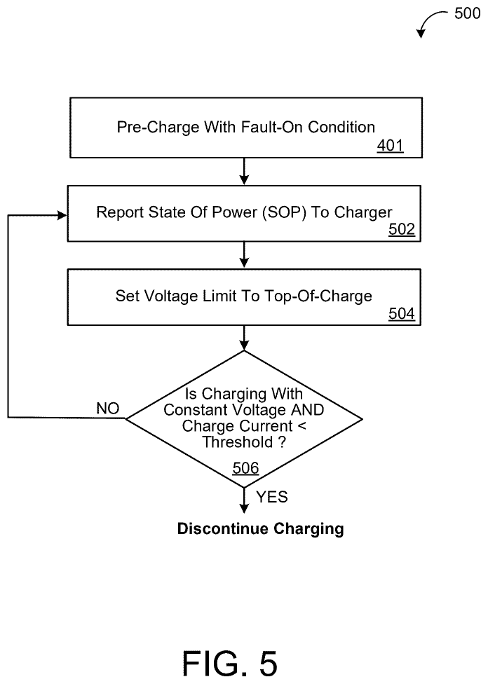

FIG. 5 is a flowchart of an example arrangement of operations for a method 500 of controlling a multi-string high-voltage battery pack 200 in a fault-on condition for charging. Here it is assumed that only a single battery string 210 is faulty and the other battery strings 210 are healthy (e.g., without a fault or operating nominally). However, method 500 can be readily extended to cover a fault in more than one battery string 210. The method 500 may be performed based on determining that a particular battery string of the plurality of battery strings is in a fault-on condition. Data processing hardware 910 (FIG. 9) may execute instructions stored on memory hardware 920 (FIG. 9) that cause the data processing hardware 910 to perform operations of the method 500. The data processing hardware 910 and the memory hardware 920 may reside on the BMU 201, the control module 16, a PCU ECU, an ECU responsible for the active discharge of a high-voltage bus, or any other ECU or control module of a vehicle 10.

At operation 401, the method 500 includes performing a pre-charge with fault-on condition process, which is shown and described in connection with FIG. 4. At operation 502, the method 500 includes reporting the SOP of the battery pack 200 to the control module 16, such that the control module 16 may control a start of charging. At operation 504, the method 500 includes setting a charging voltage limit to a top-of-charge voltage. At operation 506, the method 500 includes determining whether the charging voltage is constant and the charging current satisfies a threshold (e.g., is less than the threshold). Based on determining that the charging voltage is not constant or the charging current does not satisfy a threshold (e.g., is greater than the threshold), the method continues charging (i.e., returns to operation 502). Based on determining that the charging voltage is constant and the charging current satisfies a threshold (e.g., is less than the threshold), the method discontinues charging.

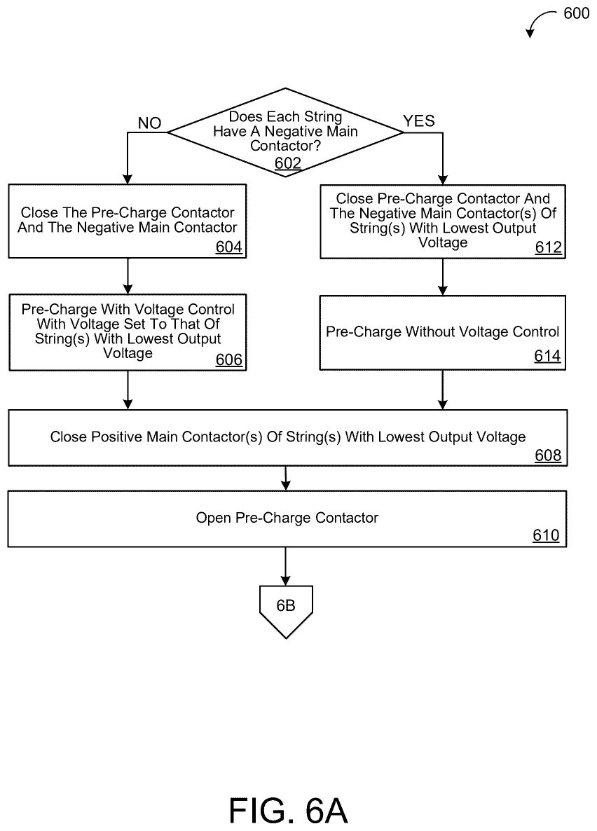

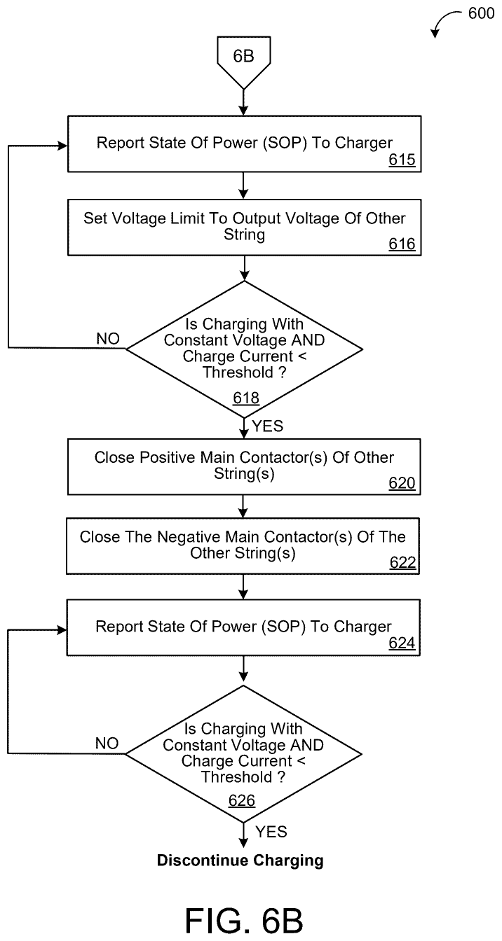

FIGS. 6A and 6B are flowcharts of an example arrangement of operations for a method 600 of controlling a multi-string high-voltage battery pack 200 in a fault-recovered condition for a charging mode. Here it is assumed that only a single battery string 210 is faulty and the other battery strings 210 are healthy (e.g., without a fault or operating nominally). However, method 600 can be readily extended to cover a fault in more than one battery string 210. The method 600 may be performed based on determining that a particular battery string of the plurality of battery strings is in a fault-recovered condition. The method 600 starts by charging the battery strings 210 with the lowest output voltages and then starts charging additional battery strings 210 as the output voltage of already being charged battery strings 210 increases. Data processing hardware 910 (FIG. 9) may execute instructions stored on memory hardware 920 (FIG. 9) that cause the data processing hardware 910 to perform operations of the method 600. The data processing hardware 910 and the memory hardware 920 may reside on the BMU 201, the control module 16, a PCU ECU, an ECU responsible for the active discharge of a high-voltage bus, or any other ECU or control module of a vehicle 10.

At operation 602, the method 600 includes determining whether each battery string 210 has its own negative main contactor 230. At operation 604, the method 600 includes, based on determining that each battery string 210 does not have its own negative contactor 230 (e.g., operation 602 is “NO”), closing the shared negative main contactor 230 and the pre-charge contactor 260. At operation 606, the method 600 includes pre-charging a load with voltage control with a target voltage equal to the lowest output voltage of the battery strings 210. Pre-charging a load with voltage control is described above in connection with operation 418 of FIG. 4. At operation 608, the method 600 includes closing the positive main contactor(s) 220 of the battery strings with the lowest output voltage. At operation 610, the method 600 includes opening the pre-charge contactor 260.

At operation 612, based on determining that each battery string 210 has its own negative contactor 230 (e.g., operation 602 is “YES”), the method 600 includes closing the negative main contactors 230 corresponding to the battery strings 210 with the lowest output voltage, and closing the pre-charge contactor 260. At operation 614, the method 600 includes pre-charging a load without voltage control. By, for example, waiting a pre-determined period of time. Thereafter, the method 600 includes closing the positive main contactor(s) 220 of the battery strings with the lowest output voltage at operation 608, and then opening the pre-charge contractor 260 at operation 610.

Continuing with FIG. 6B, at operation 615, the method 600 includes reporting the state of power (SOP) of the battery pack 200 to the control module 16, such that the control module 16 may control the start of charging. At operation 616, the method 600 includes setting a charging voltage limit to a top-of-charge voltage. At operation 618, the method 600 determines whether the charging voltage is constant and the charging current satisfies a threshold (e.g., is less than the threshold). Based on determining that the charging voltage is not constant or the charging current does not satisfy a threshold (e.g., is greater than the threshold) (e.g., operation 618 is “NO”), method 600 continues charging (i.e., returns to operation 615).

At operation 620, based on determining that the charging voltage is constant and the charging current satisfies a threshold (e.g., operation 618 is “YES”) (e.g., is less than the threshold), the method 600 includes closing the positive main contactor(s) 220 of the other battery strings 210. At operation 622, method 600 includes closing the negative main contactor(s) 230 of the other battery strings 210.

At operation 624, method 600 includes reporting the SOP of the battery pack 200 to the control module 16. At operation 626, method 600 includes determining whether the charging voltage is constant and the charging current satisfies a threshold (e.g., is less than the threshold). Based on determining that the charging voltage is not constant or the charging current does not satisfy a threshold (e.g., operation 626 is “NO”) (e.g., is greater than the threshold), method 600 continues charging and reports SOP to the control module 16 (i.e., returns to operation 624). Based on determining that the charging voltage is constant and the charging current satisfies a threshold (e.g., operation 626 is “YES”) (e.g., is greater than the threshold), method 600 discontinues charging.

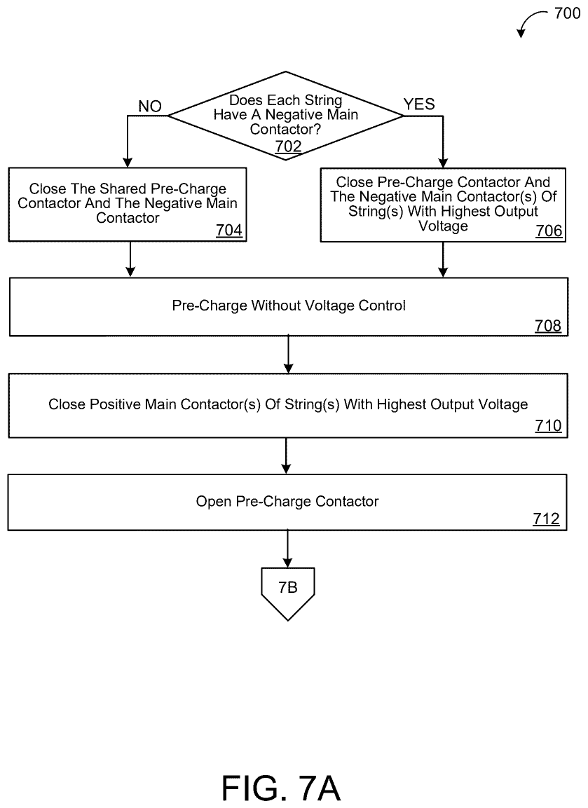

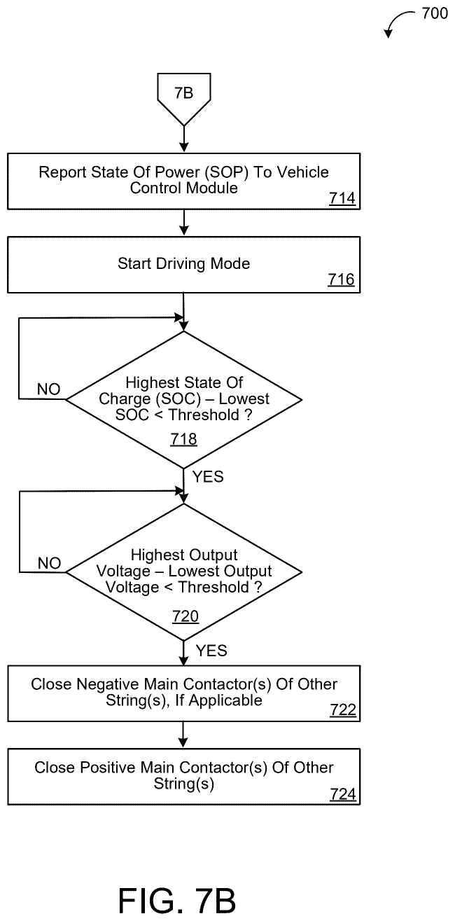

FIGS. 7A and 7B are flowcharts of an example arrangement of operations for a method 700 of controlling a multi-string high-voltage battery pack 200 in a fault-recovered condition for a driving mode. Here, it is assumed that only a single battery string 210 is faulty and the other battery strings 210 are healthy (e.g., without a fault or operating nominally). However, method 700 can be readily extended to cover a fault in more than one battery string 210. Method 700 may be performed based on determining that a particular battery string of the plurality of battery strings is in a fault-recovered condition. Method 700 starts by using the battery strings 210 with the highest output voltages and then starts using additional battery strings 210 as the output voltage of already in-use battery strings 210 decreases. Data processing hardware 910 (FIG. 9) may execute instructions stored on memory hardware 920 (FIG. 9) that cause the data processing hardware 910 to perform operations of the method 700. The data processing hardware 910 and the memory hardware 920 may reside on the BMU 201, the control module 16, a PCU ECU, an ECU responsible for the active discharge of a high-voltage bus, or any other ECU or control module of a vehicle 10.

At operation 702, method 700 includes determining whether each battery string 210 has its own negative main contactor 230. When the method 700 determines that each battery string 210 does not have its own negative main contractor 230 (e.g., operation 702 is “NO”), the method proceeds to operation 704 and closes the shared negative main contactor 230 and the pre-charge contactor 260. On the other hand, when the method 700 determines that each battery string 210 has its own negative contactor 230, the method 700 proceeds to operation 706 and closes the negative main contactor(s) 230 corresponding to the battery strings with the highest output voltage, and closes the pre-charge contactor 260. At operation 708, method 700 includes pre-charging a load without voltage control. By for example, waiting a pre-determined period of time. At operation 710, method 700 includes closing the positive main contactor(s) 220 of the battery strings with the highest output voltage. At operation 712, method 700 includes opening the pre-charge contactor 260.

Continuing with FIG. 7B, at operation 714, method 700 includes reporting the SOP of the battery pack 200 to the control module 16, such that the control module 16 may control a start of driving at operation 716. At operation 718, method 700 includes determining whether the difference between the highest SOC of a battery string 210 and the lowest SOC of a battery string 210 satisfies a first threshold (e.g., is less than the first threshold). Based on determining that the difference between the highest SOC of a battery string 210 and the lowest SOC of a battery string 210 satisfies the first threshold (e.g., operation 718 is “YES”), the method 700 proceeds to operation 720 by determining whether the difference between the highest output voltage of a battery string 210 and the lowest output voltage of a battery string 210 satisfies a second threshold (e.g., is less than the second threshold). Based on determining that the difference between the highest output voltage of a battery string 210 and the lowest output voltage of a battery string 210 satisfies the second threshold (e.g., operation 720 is “YES”), the method 700 proceeds to operation 722 by closing the negative main contactor(s) 230 of the other battery strings 210, if applicable. At operation 724, method 700 includes closing the positive main contactor(s) 220 of the other battery strings 210.

FIG. 9 is a schematic view of an example computing device 900 that may be used to implement the systems and methods described in this document. The computing device 900 is intended to represent various forms of computing devices, such as control modules, controllers, ECUs, and other appropriate computing devices 900 for use in implementing or controlling a vehicle. The components shown here, their connections and relationships, and their functions, are meant to be exemplary only and are not meant to limit implementations of the inventions described and/or claimed in this document.

The computing device 900 includes a processor 910, memory 920, a storage device 930, a high-speed interface/controller 940 connecting to the memory 920 and high-speed expansion ports 950, and a low-speed interface/controller 960 connecting to a low-speed bus 970 and a storage device 930. Each of the components 910, 920, 930, 940, 950, and 960, are interconnected using various busses and may be mounted on a common motherboard or in other manners as appropriate. The processor 910 can process instructions for execution within the computing device 900, including instructions stored in the memory 920 or on the storage device 930 to display graphical information for a graphical user interface (GUI) on an external input/output device, such as display 980 coupled to high-speed interface 940. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 920 stores information non-transitorily within the computing device 900. The memory 920 may be a computer-readable medium, a volatile memory unit(s), or a non-volatile memory unit(s). The non-transitory memory 920 may be physical devices used to store programs (e.g., sequences of instructions) or data (e.g., program state information) on a temporary or permanent basis for use by the computing device 900. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include but are not limited to, random access memory (RAM), dynamic random access memory (DRAM), static random access memory (SRAM), phase change memory (PCM) as well as disks or tapes.

The storage device 930 is capable of providing mass storage for the computing device 900. In some implementations, the storage device 930 is a computer-readable medium. In various implementations, the storage device 930 may be a floppy disk device, a hard disk device, an optical disk device, a tape device, a flash memory or other similar solid-state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 920, the storage device 930, or memory on processor 910.

The high-speed controller 940 manages bandwidth-intensive operations for the computing device 900, while the low-speed controller 960 manages lower bandwidth-intensive operations. Such allocation of duties is exemplary only. In some implementations, the high-speed controller 940 is coupled to the memory 920, the display 980 (e.g., through a graphics processor or accelerator), and to the high-speed expansion ports 950, which may accept various expansion cards (not shown). In some implementations, the low-speed controller 960 is coupled to the storage device 930 and a low-speed expansion port 990. The low-speed expansion port 990, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 900a or multiple times in a group of such servers 900a, as a laptop computer 900b, or as part of a rack server system 900c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor and can be implemented in a high-level procedural and/or object-oriented programming language, and/or in assembly/machine language. As used herein, the terms “machine-readable medium” and “computer-readable medium” refer to any computer program product, non-transitory computer-readable medium, apparatus, and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special-purpose logic circuitry, e.g., an FPGA (field programmable gate array) or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD ROM and DVD-ROM disks. The processor and the memory can be supplemented by, or incorporated in special-purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

A number of implementations have been described. Nevertheless, it will be understood that various modifications may be made without departing from the spirit and scope of the disclosure. Accordingly, other implementations are within the scope of the following claims.

What is claimed is:

1. A vehicle comprising:
an electric motor; and
a multi-string high-voltage battery pack configured to provide a high output voltage for driving the electric motor, the battery pack comprising:
a positive output terminal;
a negative output terminal;
a plurality of battery strings;
a pre-charge circuit connected to the positive output terminal and to each of the plurality of battery strings;
a plurality of positive main contactors, each positive main contactor of the plurality of positive main contactors selectively connecting a corresponding battery string to the positive output terminal; and
one or more negative main contactors connecting the plurality of battery strings to the negative output terminal.

2. The vehicle of claim 1, wherein the pre-charge circuit comprises:
a pre-charge resistor comprising first and second terminals, the first terminal of the pre-charge resistor connected to the positive output terminal;
a pre-charge contactor comprising first and second terminals, the first terminal of the pre-charge contactor connected to the second terminal of the pre-charge resistor; and
a plurality of diodes, each diode of the plurality of diodes comprising:
a first terminal connected to a corresponding battery string of the plurality of battery strings; and
a second terminal connected to the second terminal of the pre-charge contactor.

3. The vehicle of claim 1, further comprising:
a controller configured to perform operations comprising:
determining that all of the battery strings are in a normal state; and
based on determining that all of the battery strings are in the normal state:
closing the one or more negative main contactors;
closing a pre-charge contactor of the pre-charge circuit;
pre-charging the battery pack without voltage control;
closing the plurality of positive main contactors;
opening the pre-charge contactor; and
starting driving of the vehicle or charging of the battery pack.

4. The vehicle of claim 3, wherein the one or more negative main contactors comprise a shared negative main contactor, the shared negative main contactor comprising:
a first terminal connected to each of the battery strings; and
a second terminal connected to the negative output terminal.

5. The vehicle of claim 4, wherein the operations performed by the controller further comprise:
determining that a first battery string of the plurality of battery strings is in a fault-on condition; and
based on determining that the first battery string is in the fault-on condition:
closing the shared negative main contactor;
closing the pre-charge contactor;
determining that a healthy second battery string has a lower output voltage than the first battery string;
based on determining that the healthy second battery string has a lower output voltage than the first battery string, pre-charging the battery pack with voltage control;
closing the positive main contactors corresponding to healthy battery strings; and
opening the pre-charge contactor.

6. The vehicle of claim 4, wherein the operations performed by the controller further comprise:
determining that a first battery string of the plurality of battery strings is in a fault-on condition; and
based on determining that the first battery string is in the fault-on condition:
closing the shared negative main contactor;
closing the pre-charge contactor;
determining that a healthy second battery string has a higher output voltage than the first battery string;
based on determining that the healthy second battery string has a higher output voltage than the first battery string, pre-charging the battery pack without voltage control;
closing the positive main contactors corresponding to healthy battery strings; and
opening the pre-charge contactor.

7. The vehicle of claim 4, wherein the operations performed by the controller further comprise:
closing the shared negative main contactor;
closing the pre-charge contactor;
pre-charging the battery pack;
closing the positive main contactors corresponding to healthy battery strings;
opening the pre-charge contactor;
setting a charging voltage limit to a top-of-charge voltage;
charging the battery pack;
determining that a charging voltage is constant and a charging current satisfies a threshold; and
based on determining that the charging voltage is constant and the charging current satisfies the threshold, discontinuing charging of the battery pack.

8. The vehicle of claim 4, wherein the operations performed by the controller further comprise:
determining that a first battery string of the plurality of battery strings is in a fault-recovered condition; and
based on determining that the first battery string is in the fault-recovered condition:
closing the shared negative main contactor;
closing the pre-charge contactor;
pre-charging the battery pack with voltage control to an output voltage of a second battery string with a lowest output voltage;
closing the positive main contactor corresponding to the second battery string;
opening the pre-charge contactor;
setting a charging voltage limit to an output voltage of a third battery string having an output voltage greater than the lowest output voltage;
charging the battery pack;
determining that a first charging voltage is constant and the charging current satisfies a first threshold; and
based on determining that the first charging voltage is constant and the charging current satisfies the first threshold:
discontinuing charging of the battery pack;
closing the positive main contactor corresponding to the third battery string;
setting a charging voltage limit to a top-of-charge voltage;
charging the battery pack;
determining that a second charging voltage is constant and the charging current satisfies a second threshold; and
based on determining that the second charging voltage is constant and the charging current satisfies the second threshold, discontinuing charging of the battery pack.

9. The vehicle of claim 4, wherein the operations performed by the controller further comprise:
determining that a first battery string of the plurality of battery strings is in a fault-recovered condition; and
based on determining that the first battery string is in the fault condition:
closing the shared negative main contactor;
closing the pre-charge contactor;
pre-charging the battery pack without voltage control;
closing the positive main contactor corresponding to a second battery string having a highest output voltage;
opening the pre-charge contactor;
determining that an output voltage of the second battery string satisfies a threshold; and
based on determining that the output voltage of the second battery string satisfies the threshold, closing the positive main contactor corresponding to a third battery string having a lower output voltage than the output voltage of the second battery string.

10. The vehicle of claim 3, wherein:
the one or more negative main contactors comprise a negative main contractor corresponding to each battery string, and
each negative main contractor of the one or more negative main contactors comprises:
a first terminal connected to a corresponding battery string of the plurality of battery strings; and
a second terminal connected to the negative output terminal.

11. The vehicle of claim 10, wherein the operations performed by the controller further comprise:
determining that a first battery string of the plurality of battery strings is in a fault-on condition; and
based on determining that the first battery string is in the fault-on condition:
closing the negative main contactors corresponding to healthy battery strings;
closing the pre-charge contactor;
pre-charging the battery pack without voltage control;
closing the positive main contactors corresponding to the healthy battery strings; and
opening the pre-charge contactor.

12. The vehicle of claim 11, wherein the operations performed by the controller further comprise:
setting a charge voltage limit to a top-of-charge voltage;
charging battery pack;
determining that a charging voltage is constant and the charging current satisfies a threshold; and
based on determining that the charging voltage is constant and the charging current satisfies the threshold, discontinuing charging of the battery pack.

13. The vehicle of claim 10, wherein the operations performed by the controller further comprise:
determining that a first battery string of the plurality of battery strings is in a fault-recovered condition; and
based on determining that the first battery string is in the fault-recovered condition:
closing the negative main contactor corresponding to a second battery string having a lowest output voltage;
closing the pre-charge contactor;
pre-charging the battery pack without voltage control;
closing the positive main contactor corresponding to the second battery string;
opening the pre-charge contactor;
setting a charge voltage limit to voltage of a third battery string having an output voltage greater than the lowest output voltage;
charging the battery pack;
determining that a first charging voltage is constant and the charging current satisfies a first threshold; and
based on determining that the first charging voltage is constant and the charging current satisfies the first threshold:
discontinuing charging of the battery pack;
closing the positive main contactor corresponding to the third battery string;
setting a charge voltage limit to a top-of-charge voltage;
charging the battery pack;
determining that a second charging current is constant satisfies a second threshold; and
based on determining that the second charging voltage is constant and the charging current satisfies the second threshold, discontinuing charging of the battery pack.

14. The vehicle of claim 10, wherein the operations performed by the controller further comprise:
determining that a first battery string of the plurality of battery strings is in a fault-recovered condition; and
based on determining that the first battery string is in the fault-recovered condition:
closing the negative main contactor corresponding to a second battery string having a highest output voltage;
closing the pre-charge contactor;
pre-charging the battery pack without voltage control;
closing the positive main contactor corresponding to the second battery string;
opening the pre-charge contactor;
determining that an output voltage of the second battery string satisfies a threshold; and
based on determining that the output voltage of the second battery string satisfies the threshold, closing the positive main contactor corresponding to a third battery string.

15. A computer-implemented method executing on data processing hardware that causes the data processing hardware to perform operations for controlling a multi-string high-voltage battery pack of a vehicle to provide a high output voltage for driving an electric motor of the vehicle, the operations comprising:
closing one or more negative main contactors of the battery pack, the one or more negative main contactors connecting a plurality of battery strings of the battery pack to a negative output terminal of the battery pack;
closing a pre-charge contactor of a pre-charge circuit of the battery pack, the pre-charge circuit connected to:
a positive output terminal of the battery pack; and
each of the plurality of battery strings;
pre-charging the battery pack;
closing a plurality of positive main contactors of the battery pack, each positive main contactor of the plurality of positive main contactors selectively connecting a corresponding battery string to the positive output terminal; and
opening the pre-charge contactor.

16. The computer-implemented method of claim 15, wherein the one or more negative main contactors comprises a shared negative main contactor, the shared negative main contactor comprising:
a first terminal connected to each of the battery strings; and
a second terminal connected to the negative output terminal.

17. The computer-implemented method of claim 16, wherein the operations further comprise:
determining that a first battery string of the plurality of battery strings is in a fault-on condition; and
based on determining that the first battery string is in the fault-on condition:
closing the shared negative main contactor;
closing the pre-charge contactor;
determining that a healthy second battery string has a lower output voltage than the first battery string;
based on determining that the healthy second battery string has a lower output voltage than the first battery string, pre-charging the battery pack with voltage control;
closing the positive main contactors corresponding to healthy battery strings; and
opening the pre-charge contactor.

18. The computer-implemented method of claim 16, wherein the operations further comprise:
determining that a first battery string of the plurality of battery strings is in a fault-on condition; and
based on determining that the first battery string is in the fault-on condition:
closing the shared negative main contactor;
closing the pre-charge contactor;
determining that a healthy second battery string has a higher output voltage than the first battery string;
based on determining that the healthy second battery string has a higher output voltage than the first battery string, pre-charging the battery pack without voltage control;
closing the positive main contactors corresponding to healthy battery strings; and
opening the pre-charge contactor.

19. The computer-implemented method of claim 16, wherein the operations further comprise:
closing the shared negative main contactor;
closing the pre-charge contactor;
pre-charging the battery pack;
closing the positive main contactors corresponding to healthy battery strings;
opening the pre-charge contactor;
setting a charging voltage limit to a top-of-charge voltage;
charging the battery pack;
determining that a charging voltage is constant and the charging current satisfies a threshold; and
based on determining that the charging voltage is constant and charging current satisfies the threshold, discontinuing charging of the battery pack.

20. The computer-implemented method of claim 16, wherein the operations further comprise:
determining that a first battery string of the plurality of battery strings is in a fault-recovered condition; and
based on determining that the first battery string is in the fault-recovered condition:
closing the shared negative main contactor;
closing the pre-charge contactor;
pre-charging the battery pack with voltage control to an output voltage of a second battery string with a lowest output voltage;
closing the positive main contactor corresponding to the second battery string;
opening the pre-charge contactor;
setting a charging voltage limit to an output voltage of a third battery string having an output voltage greater than the lowest output voltage;
charging the battery pack;
determining that a first charging voltage is constant and the charging current satisfies a first threshold; and
based on determining that the first charging voltage is constant and the charging current satisfies the first threshold:
discontinuing charging of the battery pack;
closing the positive main contactor corresponding to the third battery string;
setting a charging voltage limit to a top-of-charge voltage;
charging the battery pack;
determining that a second charging voltage is constant and charging current satisfies a second threshold; and
based on determining that the second charging voltage is constant and charging current satisfies the second threshold, discontinuing charging of the battery pack.

21. The computer-implemented method of claim 16, wherein the operations further comprise:
determining that a first battery string of the plurality of battery strings is in a fault-recovered condition; and
based on determining that the first battery string is in the fault condition:
closing the shared negative main contactor;
closing the pre-charge contactor;
pre-charging the battery pack without voltage control;
closing the positive main contactor corresponding to a second battery string having a highest output voltage;
opening the pre-charge contactor;
determining that an output voltage of the second battery string satisfies a threshold; and
based on determining that the output voltage of the second battery string satisfies the threshold, closing the positive main contactor corresponding to a third battery string having a lower output voltage than the output voltage of the second battery string.

22. The computer-implemented method of claim 15, wherein:
the one or more negative main contactors comprise a negative main contractor corresponding to each battery string, and
each negative main contractor of the one or more negative main contactors comprises:
a first terminal connected to a corresponding battery string of the plurality of battery strings; and
a second terminal connected to the negative output terminal.

23. The computer-implemented method of claim 22, wherein the operations further comprise:
determining that a first battery string of the plurality of battery strings is in a fault-on condition; and
based on determining that the first battery string is in the fault-on condition:
closing the negative main contactors corresponding to healthy battery strings;
closing the pre-charge contactor;
pre-charging the battery pack without voltage control;
closing the positive main contactors corresponding to the healthy battery strings; and
opening the pre-charge contactor.

24. The computer-implemented method of claim 23, wherein the operations further comprise:
setting a charge voltage limit to a top-of-charge voltage;
charging the battery pack;
determining that a charging voltage is constant and the charging current satisfies a threshold; and
based on determining that the charging voltage is constant and charging current satisfies the threshold, discontinuing charging of the battery pack.

25. The computer-implemented method of claim 22, wherein the operations further comprise:
determining that a first battery string of the plurality of battery strings is in a fault-recovered condition; and
based on determining that the first battery string is in the fault-recovered condition:
closing the negative main contactor corresponding to a second battery string having a lowest output voltage;
closing the pre-charge contactor;
pre-charging the battery pack without voltage control;
closing the positive main contactor corresponding to the second battery string;
opening the pre-charge contactor;
setting a charge voltage limit to the voltage of a third battery string having an output voltage greater than the lowest output voltage;
charging the battery pack;
determining that a first charging voltage is constant and charging current satisfies a first threshold; and
based on determining that the first charging voltage is constant and charging current satisfies the first threshold:
discontinuing charging of the battery pack;
closing the positive main contactor corresponding to the third battery string;
setting a charge voltage limit to a top-of-charge voltage;
charging the battery pack;
determining that a second charging current is constant satisfies a second threshold; and
based on determining that the second charging voltage is constant and the charging current satisfies the second threshold, discontinuing charging of the battery pack.

26. The computer-implemented method of claim 22, wherein the operations further comprise:
determining that a first battery string of the plurality of battery strings is in a fault-recovered condition; and
based on determining that the first battery string is in the fault-recovered condition:
closing the negative main contactor corresponding to a second battery string having a highest output voltage;
closing the pre-charge contactor;
pre-charging the battery pack without voltage control;
closing the positive main contactor corresponding to the second battery string;
opening the pre-charge contactor;
determining that an output voltage of the second battery string satisfies a threshold; and
based on determining that the output voltage of the second battery string satisfies the threshold, closing the positive main contactor corresponding to a third battery string.
